(19) United States
(12) Patent Application Publication
(10) Pub. No.: US 2012/0208611 A1
(43) Pub. Date: Aug. 16, 2012

(54) METHOD FOR GAME ANALYSIS

(75) Inventor: Mirko Marcolini, Montelabbate (IT)

(73) Assignee: K-SPORT DI MARCOLINI MIRKO, Montelabbate (PU) (IT)

(21) Appl. No.: 13/501,521

(22) PCT Filed: Oct. 12, 2010
(86) PCT No.: PCT/IB10/02593

§ 371 Date: May 1, 2012

(30) Foreign Application Priority Data
Oct. 12, 2009 (EP) 09425400

(51) Int. Cl. A63F 9/24; A63F 13/00

(52) U.S. Cl. 463/7

(57) ABSTRACT

Process for the disposal of wastes, comprising: performing an acid oxidizing hydrolysis of the incoming waste (charge); performing an alkaline oxidizing hydrolysis of the outgoing mass from the stage of acid oxidizing hydrolysis; chemically conditioning the outgoing mass from the stage of alkaline oxidizing hydrolysis by the addition of an acid reagent; separating any undissolved residue. This process, by comparison with other methods and technologies already known and in use, features the following advantages: superior effectiveness in reducing the weight of the waste,—superior economy; total absence of ecological, environmental, hygiene and sanitary problems; total safety of personnel employed at the plants; enhancement for agricultural use of any exhausted residue which may be present at the end of the treatment.

The present invention relates to a measuring method for obtaining quantitative data relating to an athlete's performances. In particular, the present invention relates to a measuring method for obtaining quantitative data relating to an athlete's technical and tactical performances. In more detail, the present invention relates to a measuring method for obtaining quantitative data relating to the technical and tactical performances of an athlete engaged in a team competition.

### BACKGROUND TO THE INVENTION

The analytical study of the match performances of the players of a team (the so-called match analysis) has an increasingly great significance in the current competitive sport practice. This procedure comprises the post-match analysis of athletes' behaviours during competitions from the athletic, technical, tactical and psychological view point. Currently, this performance analysis is however carried out with highly uncertain and subjective methods, and therefore it does not support adequately coaches and trainers, who must set up training routines, formations and schemes based upon this analysis. In particular, analysis of the players' technical behaviour is currently based upon simple statistics, that are often automatically calculated and put all the events of a match on the same level, without taking account of the technical value of the individual events. Similarly, a reliable method for analysing tactical characteristics of the players is currently unavailable. In particular, current match analysis procedures simply provide for recording the position on the field of the players involved in a given event, for instance a pass or a shot, without analytically assessing the effectiveness of each of these events for the match. Lastly, analytical methods are not currently known for measuring players' psychological performances, that are currently evaluated based upon simple “sociograms” only indicating the number of passes to team members.

In view of the above description it is therefore clearly apparent that the problem of having available a method for measuring the performances of athletes during competitive sport events is currently unsolved and represents an interesting challenge for the applicant, that aims at identifying a method for measuring the performances of an athlete during a sport match that gives reliable and reproducible quantitative data suitable to describe these performances both from the athletic and technical and tactical, as well as psychological view point.

### SUMMARY OF THE PRESENT INVENTION

The present invention relates to a measuring method for obtaining quantitative data relating to an athlete's performances. In particular, the present invention relates to a measuring method for obtaining quantitative data relating to an athlete's technical and tactical performances. In more detail, the present invention relates to a measuring method for obtaining quantitative data relating to the technical and tactical performances of an athlete engaged in a team competition.

The object of the present invention is to provide a method that is validly usable to obtain quantitative data concerning the performance of an athlete engaged in a sport team competition.

According to the present invention a method is provided for obtaining quantitative data concerning the performances of an athlete, and the main characteristics of this method will be described in at least one of the following claims.

### BRIEF DESCRIPTION OF DRAWINGS

Further characteristics and advantages of the method according to the present invention will be more apparent from the description below, set forth with reference to the accompanying drawings, which illustrate some non-limiting examples of embodiment. In particular:

FIG. 1 shows in time sequence a playfield, subdivided into respective reference areas obtained by applying the present method.

### DETAILED DESCRIPTION OF THE PRESENT INVENTION

The present invention relates to a measuring method for obtaining quantitative data relating to the performances of at least one participant in a sport event, for instance a match or training, occurring on a play surface 100 with a plurality of participants 20 moving within this play surface 100. Preferably, these participants 20 are suitable reciprocally to interact through a given body 30, for example a ball or a disk, which is also suitable, in use, to move freely within this play surface 100. It should be noted that, for the sake of simplicity, reference will be made hereafter only to a football match, without however limiting the general scope of the method according to the present invention, that, as it will be clear from the description below, can be freely applied to any sports with a plurality of participants 20 reciprocally interacting through a ball 30, a disk, a shuttlecock, or any other game object. The present method can be applied to a single player 21 for obtaining quantitative data concerning his/her respective performance during a match or training or, more advantageously, it can be applied to all the players 21 of a team 25 for obtaining data relating to the technical, tactical and psychological performance of the whole team, that is therefore interpreted as a single subject involved in the match or the training to be analysed. It should be noted that, by analysing a plurality of chronologically different matches and/or trainings with the method according to the present invention, it will be possible to define a complete statistic on the performances of the individual players 21, which allows to know, for each of them, the trend over time of the technical, tactical and psychological characteristics.

At this point it should be illustrated how the method according to the present invention is applied to a generic football match for obtaining, through analysis of this match, quantitative data expressing the characteristics and the performances of at least one given player 21 of a team 25 involved in that match.

First of all, the method according to the present invention comprises a phase of acquiring kinematic data concerning at least the given player 21 during the match to be analysed. To implement the present method effectively it is however preferable that this phase of acquiring kinematic data concerning at least one given player 21 comprises a phase of acquiring kinematic data concerning each player 21 of the team 25 and, if necessary, each opponent 22 of the opposite team 26. These kinematic data comprise preferably the position within the play surface 100, the speed and the acceleration of the individual participants 20 in the match and of the ball 30. It should be noted that the kinematic data in question are measured in a substantially continuous manner during the match through a respective tracing apparatus suitable, in use, to record moment by moment the position of the players 21 and/or of the opponents 22 and of the ball 30 within the play surface 100. In this case the speed and instantaneous acceleration of the participants 20 can be acquired numerically through derivation of data concerning the position of the participants 20 relative to the time. Without limiting the present invention, this tracing apparatus can preferably comprise a group of static cameras suitable, in use, to frame the entire play surface 100 during all the match. The produced film can be analysed by an image recognition software (computer vision) suitable to trace and reproduce, moment by moment, the positions and displacements of all the participants 20 (including referee and linesmen) and of the ball 30. Tracing apparatuses of different type can be alternatively used, comprising, in combination or alternatively, GPS devices or RFID transmitters worn by the players and inserted in the ball. It should be noted that the kinematic data in question for analysing the performances of players can be obtained both delayed from digital signals recorded during the match and in real-time through data flows transmitted by means of a wireless technology of the known type.

The method according to the present invention further comprises a phase of acquiring personal data concerning at least the given player 21. In this case again it would be preferable to have available personal data concerning all the participants 20, or at least each player 21 of the team 25, whose performances you want to analyse quantitatively. Preferably, although without limitation, these personal data can comprise:

data concerning the athletic characteristics of the participants 20/players 21;

data concerning the current athletic condition of the participants 20/players 21;

data concerning the ability of each participant 20/player 21 successfully to face a given sport event occurring during the match, for instance confrontation, dribbling, pass, shot on goal, etc.

Just by way of non-limiting example, data concerning the athletic characteristics of a given player 21 can comprise mean or peak (record) values of speed, acceleration and elevation previously recorded by this player for instance during training. Analogously, data relating to the current athletic condition can comprise one or more physical efficiency coefficients C_{f} quantifiable as percentage of the athletic skills that the given player 21 is able to express in a moment considered as current moment for the present analysis. Lastly, data concerning the ability to face successfully a given event can comprise a coefficient for each type of event, quantifying the probability of success for the given player 21 in that type of events. Hereinafter these coefficients will be indicated as S^{E} where the index E indicates the type of event and can indicate a pass, a shot on goal, a tactical displacement, a dribbling etc. It should be noted that these personal data can be provided manually by an operator who wants to implement the present method, or they can be calculated automatically as given functions of the outputs obtained by applying the present method to previous matches or training or, as it will be explained below, in real-time during the sport event in question. It should be also noted that these personal data can be maintained constant during analysis of the whole match, or they can be modified, selectively or automatically, so as to reflect a change in the personal characteristics or skills of the given player 21. Data concerning the current athletic condition can be modified, for instance, manually following an injury, or they can be modified automatically, and in real-time if necessary, through an algorithm that takes into account the fatigue accumulated during the match. Analogously, the data/coefficients reflecting the efficiency of a given player 21 in facing a given event can be constants based upon statistics of the previous sport activity of this player 21 or they can be calculated in real-time during the match based upon how this given player 21 faces, and may be overcomes, these events during the match to be analysed.

At this point, the method according to the present invention comprises a phase of processing the previously acquired kinematic and/or personal data for obtaining the value of given parameters that will be better illustrated hereafter and that allow to quantify the performances of the players during the sport event. This phase of processing previously acquired data can be carried out through a computer or any electronic device with sufficient computing capability.

The phase of processing the kinematic and personal data comprises firstly the phase of defining for at least one given player 21 a respective portion 10 of the play surface 100, this surface portion 10 is defined as the locus of points of the play surface 100 that this given player 21 can achieve before any other participant within a given time interval ΔT. In other words, each surface portion 10 represents the portion of the play surface 100 where the respective player 21 (or opponent 22) would prevail over the ball 30 relative to any other participant 20 in the match. In this regard, it should be noted that the definition of each surface portion 10 associated to a given player 21 in a given instant is linked:

with the kinematic status (position, speed and acceleration) of the given player 21 in the given moment;

with the time interval AT selected to perform the analysis;

with the athletic characteristics of the given player 21;

with the physical efficiency coefficient C_{f} of the given player 21 in the given instant.

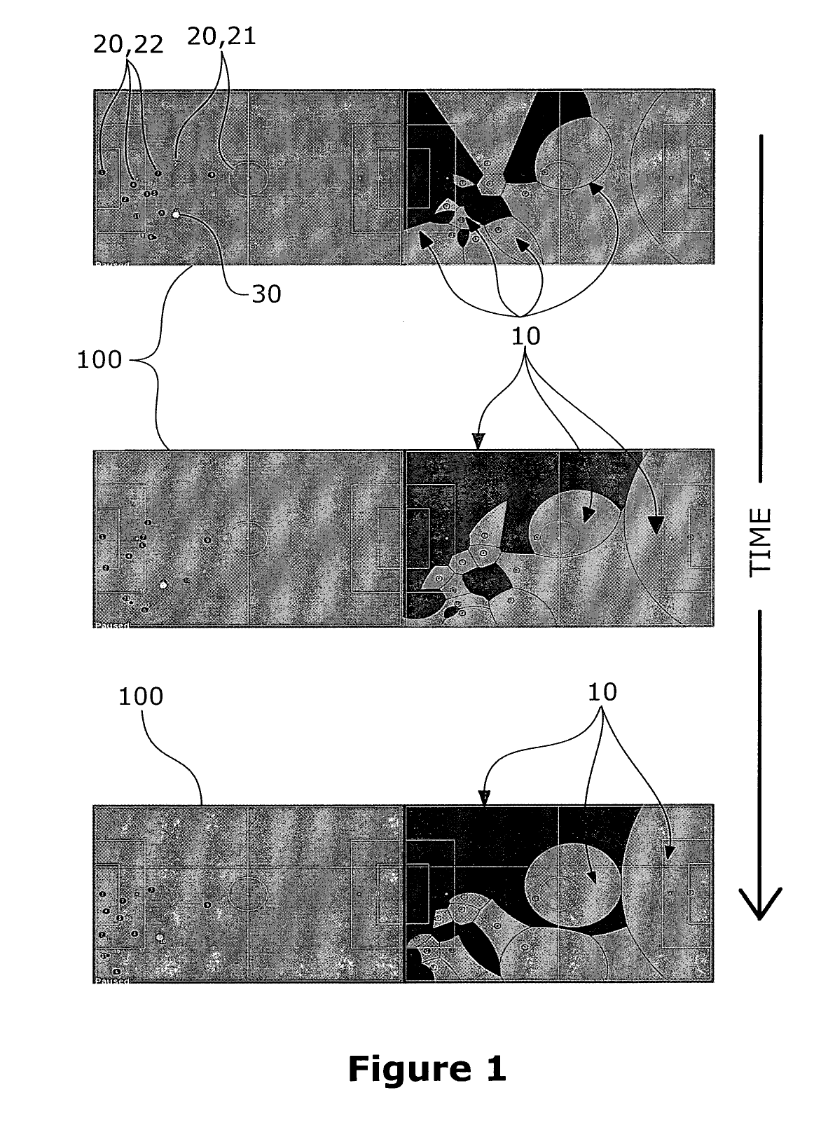

In this regard it should be specified that the value of the time interval ΔT can be selected freely, however the analysis will be more effective when it will be carried out according to a value of the time interval ΔT consistent with the type of event under study. If you want to analyse, for instance, long balls, it will be necessary to assign to the time interval ΔT a significantly greater value than that assigned to the time interval ΔT when you are studying short passes at the edge of the area or shots on goal from a position within the penalty area. At this point it should be specified that the method in question preferably provides for defining a surface portion 10 concerning a given time interval ΔT for each participant 20 (including referee) in the football match so that, for each value assigned to the given time interval ΔT it is possible to carry out a phase of subdividing the play surface 100 into a plurality of portions 10, whose overall number is equal to the number of the participants in the football match. The output of this phase is illustrated in FIG. 1, where a sequence is illustrated, in chronological succession, of various subdivisions of the play surface 100 into the respective surface portions 10. As it is shown in FIG. 1, these subdivisions of the surface 100 develop over time based upon kinematic data of the participants 20, whose positions are also illustrated in FIG. 1 for comparison. It should be furthermore noted that the acquired kinematic data, and possibly also some personal data, of each participant 20 are defined moment by moment, so as to describe the evolution over time of the position and of the athletic behaviour of the participants 20. Therefore, also the conformation and the area of the portions 10 of the play surface 100 will change moment by moment according to the corresponding kinematic and personal data, as illustrated in the chronological sequence of FIG. 1. It should be specified that the phase of defining the surface portions 10 illustrated above represents one of the most significant and innovative characteristics of this method, as defining these portions 10 allows to carry out a quantitative assessment of athletic or tactical performances by numerically comparing mathematical relations having, as independent variants, the position and the area of surface portions 10.

At this point it should be noted that a match, or any other sport event, can be interpreted as a succession of a plurality of events potentially of different types. A football match can be interpreted for example as a time succession of actions of different types; these actions can be displacements of players, with or without ball, passes, shots, place kicks, one-on-one for the ball, etc. According to this method, a player's performance during a match as regards at least one single event or at least one type of events can be quantified through at least one given parameter, which can be preferably expressed as a value comprised between 1 and 100 and interpreted as the success percentage in this event/type of events.

After having defined the portions 10 of the play surface 100, the phase of processing kinematic and/or personal data of the participants 20 therefore comprises the phase of calculating the value of at least one given parameter that describes in quantitative terms the performances of a respective given player 21 concerning a given event and/or a given type of events.

In particular, with reference to football match or other team sports, the phase of calculating the value of at least one given parameter comprises the phase of calculating the value of a first parameter P suitable to quantify the performance of a given player 21 while executing a given event of passing the ball to a team member. This phase of calculating the value of a first parameter P will comprise a phase of identifying the best pass for this given event and a phase of quantifying the ratio between the pass really performed by the given player 21 during this given event and the best pass for this given event. “Best pass” means the pass that would be most effective based upon the kinematic and/or personal conditions of the participants 20 in the initial moment of the given event of passing. In particular, the phase of identifying the best pass for the given event can be carried out by identifying the pass solution that maximizes a function having as variables at least one quantity among:

n that indicates the n-th player 21, to whom the ball is passed (in shot n ε[1-10]);

Aₙ that indicates the area of the surface portion 10 associated with the n-th player;

Dₙ that is the distance between the portion 10 associated with the n-th player and the centre of the goal.

Further variables of this function can be:

Sₙ^{E} that quantifies the probability of success of the event E subsequent to the pass made by the n-th player who has received the pass;

C, that represents the difficulty of making the pass to the n-th player.

Therefore, the following are non-limiting examples of the function to be maximized to identify the best pass solution:

F_{best}_{ₚₐₛₛ}a×f(Aₙ)+b×g(Dₙ)

$${F}_{{best}_{pass}} = a \times f ( {A}_{n} ) + b \times g ( {D}_{n} ) + c \times h ( {\sum }_{E} {q}_{n}^{E} {S}_{n}^{E} )$$

$${F}_{{best}_{pass}} = a \times f ( {A}_{n} ) + b \times g ( {D}_{n} ) + c \times h ( {\sum }_{E} {q}_{n}^{E} {S}_{n}^{E} ) + d \times l ( 1 / {C}_{n} )$$

Where f, g, h, l are given increasing functions, while a, b, c are pre-set constant parameters typical of the function F_{best}_{ₚₐₛₛ}. Also qₙ^{E} are coefficients associated to the n-th player, that quantify his/her predisposition to face a type of given events E rather than another type.

Therefore, by maximizing the function F_{best}_{ₚₐₛₛ} it will be possible to identify the pass solution that would have been the best one in the moment the analysed passage has been performed, taking into account not only the difficulty of the pass, but also the effectiveness of the selected pass for the purpose of getting a goal or, more in general, achieving a preset target. For example, taking into account the technical skills of the n-th player, quantified by the parameters Sₙ^{E}, it will be possible to decide quantitatively which of the following actions would have had a greater possibility of success: executing a difficult pass to a player who is in good position to shot or executing a simpler pass to a player who can only cross across the penalty area. In this regard it is clear that the phase of calculating the value of a first parameter P comprises a phase of defining the difficulty in performing a pass to at least one given player 21 (n-th player). This phase is carried out by assigning a value to the parameter Cₙ, associated to the pass towards the given player 21, that can be calculated as a function of at least one of the following variables:

Aₙ that indicates the area of the surface portion 10 associated with the n-th player;

Tₙ^{volo} that represents the time interval from the moment in which the ball is kicked to the moment in which the ball reaches the n-th player. This time interval Tₙ^{volo} can be also used as time interval ΔT to define the portions 10 of the surface 100 during the execution of a pass;

Dₙ^{Pass} that represents the distance between the start position and the final position of the ball;

Dₙ^{Tr-avv} that represents the distance between the ball trajectory and the surface portions 10 associated with the opponents 22 who are near the pass trajectory. This variable can be estimated, for instance, as a linear function of the sum between the minimum distance of the portions 10 associated with the opponents 22 developing on the right side of the pass trajectory and the minimum distance of the portions 10 associated with the opponents 22 developing on the left side of the pass trajectory;

D^{Tr-Com} that represents the distance between the ball trajectory and the surface portions 10 associated with the teammates of the team 25 different than the n-th player 21;

Dₙ^{Tr-ref} that represents the distance between the ball trajectory and the surface portions 10 associated with the referee and the linesmen;

ASₙ that represents the angle that, in the start moment of the given pass, has its vertex in the ball (or in the centre of gravity of the player possessing the ball) and sides tangential to the portions 10 associated with the opponents that are nearest to the pass trajectory.

Further variables that can be taken into account to define the difficulty of a pass relate to the technical characteristics of the player 21 who must make the pass. These variables are:

X1, representing a critical length below which the distance between the player 21 who must pass and a portion associated with an opponent is deemed dangerous. Clearly, the greater the grip capacity of the player, the lower the value of X1 and, similarly, the greater the number of portions 10 associated with the opponents, who are at distances lower than X1, the greater the difficulty of the pass;

X2, representing a critical distance, below which the presence of a member of the team 25 is deemed to be an obstacle, as he/she could unintentionally hinder the pass. In this case again, the greater the grip capacity of the player performing the pass, the lower the value of X2.

Therefore, in view of the above description, the parameter Cₙcan be calculated through one of the functions in the following list, set forth by way of non-limiting example:

Cₙ=b′×Tₙ^{volo}+c′×Dₙ^{Pass}

Cₙ=a′×f′(Aₙ)+b′×g′(Tₙ^{volo})+c′×h′(Dₙ^{Pass})+d′l(Dₙ^{Tr-avv})

Cₙ=a′×f′(Aₙ)+b′×g′(Tₙ^{volo})+c′×h′(Dₙ^{Pass})+d′l(Dₙ^{Tr-avv}, X1)×e′m′(Dₙ^{Tr-Com}, X2)

Where f′, g′, h′, l′, m′ are given increasing functions, while a′, b′, c′, e′ are preset constant parameters.

It should be noted that the method according to the present invention can provide for a phase of calculating a second parameter P′ suitable to quantify the overall performance of the given player 21 during the match concerning the ball pass events. The parameter P′ can be for example expressed as the percentage of passes made during the match, wherein the made pass does not significantly differ from the respective best pass. In other words, each parameter P can be expressed as a percentage indicating how the made pass is similar to the best pass (100%=best pass), while P′ represents the percentage of the passes made by the given player 21 that present P greater than a given critical value, for example 80%.

Alternatively, P′ can be defined as the arithmetic mean or weighing of a plurality of first parameters P concerning distinct pass events; in particular, to take into account the difficulty of the made passes, the statistical weights usable to calculate P′ can be proportional to the respective coefficients Cₙ.

It is therefore clearly apparent that the use of the first parameters P and of the respective parameters Cₙ concerning a plurality of pass events, and even more of the second parameter P′, allows to evaluate not only the technical performance of the given player 21 who has passed the ball (the more he/she successfully performs passes with high Cₙ, the more he/she is capable), but also the psychological performance and the insight in the passes of this player. In fact, for example, a player tending only to perform easy passes could have low technical training or simply he could be not fully aware of his potential. In this case, applying this method to a plurality of sport events (training, matches, etc.) in chronological succession allows to solve the question and to identify the effective technical, tactical and psychological potentialities of the player, as it allows to identify the variation in the player's performances and the average difficulty of the passes made as the athletic preparation and the tactical and psychological awareness of this player increase.

At this point it should be noted that the parameters P, P′, used to quantify the performance of a given player 21 concerning the pass events, can be also used to quantify the performance of this player 21 as regards the performances of shot at goal. For this purpose it is sufficient to use the same algorithms and the same coefficients used for calculating the parameters P, P′ e Cₙ by replacing the n-th player receiving the ball and the respective surface portion 10 with the opponents' goal and with a respective surface proportional to the rectangular area of the goal, delimited by posts and crossbar and definable for example as projection of the goal rectangle relative to the shot position. It should be specified that in football the goal can be interpreted as a goal area, whose conformation and dimension will change according to the sport event under analysis. In the case of a shot towards this goal/goal area, the parameters P and P′ will be identified respectively as third parameter T and fourth parameter T′ suitable to quantify respectively the player's performance in a single shot event or in a plurality of shots at goal, whilst the parameters Cₙ can be used to evaluate the difficulty of the shots.

It is therefore clearly apparent that, in this case again, the use of the third parameters T and of the respective parameters Cₙ concerning a plurality of events of shots at goal and, even more, of the fourth parameter T′, allows to evaluate not only the technical performance of the given player 21 who has performed the shot (the more he/she successfully performs shots with high Cₙ, the more he/she is capable), but also the psychological performance and the insight of this player 21 in the events of shot at goal.

At this point it should be noted that the phase of calculating the value of at least one given parameter comprises the phase of calculating the value of a fifth parameter M suitable to quantify the performance of a given player 21 during the execution of a respective displacement within the play surface 100. This parameter M will be quantified differently according to the type of event within which this displacement of the given player 21 occurs. In particular, if the displacing given player 21 is the intended receiver of a pass, the more his/her displacement allows to increase the surface portion 10, and therefore the more it allows to decrease the pass difficulty for the player performing it, the more the displacement is effective. Furthermore, the displacement effectiveness can be quantified also as a function of the possibility of success of the subsequent event following the displacement in question, for example a shot or a further pass. Therefore, to calculate the fifth parameter M relative to a displacement aimed at receiving a given pass, this method will comprise a phase of identifying the best displacement according to the given pass, followed by a phase of quantifying the ratio between the displacement actually made by the player during this pass and the best displacement for this given pass. The phase of identifying the best displacement can be performed simply by minimising the parameter Cₙ related to this given pass or maximising a function that is in inverse proportion to the parameter Cₙ related to this given pass and proportional to the possibility of success of an event subsequent the displacement under analysis. Examples of this function are the following:

F_{best}_{ₛₚₒₛₜ}=a″×f″(Aₙ)+b″×g″(1/Cₙ)

$${F}_{{best}_{spost}} = {a}^{″ } \times {f}^{″} ( {A}_{n} ) + {b}^{″} \times {g}^{″} ( 1 / {C}_{n} ) + {c}^{″} \times {h}^{″} ( {\sum }_{E} {q}_{n}^{E} {S}_{n}^{E} )$$

where, in this case:

Aₙ indicates the area of the surface portion 10 associated with the given player 21 performing the displacement;

Cₙ represents the coefficient of difficulty of the pass towards the given player 21 performing the displacement

f″, g″, h″, are given increasing functions, while a″, b″, c″ are preset constant parameters typical of the function F_{best}_{ₘₒᵥ}. Also qₙ^{E} are coefficients that are associated with the given player 21 performing the displacement and that quantify his/her percentage of success in facing the given event E subsequent the pass.

The above described approach can be generalised and used also for calculating a fifth parameter M associated with a displacement in defensive phase where the movement of the given player 21 under analysis, for example a defender or a goalkeeper, has the purpose of minimising the surface portion 10 associated with an opponent 22 and to maximise the difficulty coefficient Cₐᵥᵥ associated with the shot or the pass of the opponent 22. In this case the function to be maximised numerically can have, for example, the following form:

F_{best}_{ₛₚₒₛₜ}=a″×f″(1/Aₐᵥᵥ)+b″×g″(Cₐᵥᵥ)

Where:

Aₐᵥᵥ indicates the area of the surface portion 10 associated with the opponent 22 whose pass/shot you desire to hinder.

Lastly, the above illustrated approach can be used also to evaluate the effectiveness of a displacement of a given player 21 possessing the ball. In this case, the player's displacement shall aim at increasing his/her portion 10 of the play surface 100 and at maximising the success of the event subsequent the execution of the displacement. In other words, to evaluate the effectiveness of a displacement through a respective fifth parameter M it will be necessary to compare the different displacements possible for the player, so as to identify the displacement that would have brought him/her in the best position to take part in a subsequent event, for example a shot at goal, a dribbling or a pass. It is clearly apparent that, to identify the best displacement relative to the circumstances under analysis, it is necessary to use also the possibilities of success typical of the given player 21 relative to the possible events following the given displacement. From a numerical point of view, this phase of identifying the best displacement can be performed by maximising a function that is proportional to the surface portion 10 associated with the given player 21 and takes into account all the possible events following the displacement in the light of the success possibilities of this event. This function can present, for instance, the following form:

$${F}_{{best}_{spost}} = {a}^{″ } \times {f}^{″} ( {A}_{n} ) + c \times {h}^{″} ( {\sum }_{E} {q}_{n}^{E} {S}_{n}^{E} )$$

Where the values of Sₙ^{E} concerning shots and passes can correspond or be estimated based upon the respective coefficients Cₙ.

In view of the above description it is clearly apparent that calculation of each fifth parameter M allows to quantify the effectiveness of the displacements of a given player and therefore to evaluate his/her tactical and psychological skills. At this point, the method according to the present invention comprises a phase of calculating a sixth parameter M′. In this case again, as for the first and second parameters P and P′, the sixth parameter M′ can be defined as the percentage of the displacements made by a given player 21 that present a respective fifth parameter M greater than a given high critical value. Alternatively, the sixth parameter M′ can be defined as an arithmetic mean or weighing of a plurality of fifth parameters P concerning distinct displacements of the given player 21; in particular, to take into account the difficulty of the received passes or of the made shots, the statistical weights usable to calculate the sixth parameter M′ can be proportional to the respective coefficients Cₙ.

At this point it should be noted that this method can comprise a phase of updating personal data of the given player 21 based upon parameters P′, T′ and M′ calculated relative to a given sport match/event, processing the kinematic and personal data of the given player 21. It is therefore clearly evident that the method according to the present invention can be an iterative method that, through subsequent approximations, allows to define with ever-increasing accuracy the technical, tactical and psychological characteristics of the players 21 of the team 25. For example, by applying this method to a ever-increasing number of training and matches it will be possible to update continuously the values of the coefficients S^{E} quantifying the success possibilities for the given player 21 in a given event E. Alternatively, these coefficients S^{E}, as well as the coefficient C_{f}, quantifying the current physical and athletic efficiency of the given player 21, can be updated in real time during a match or training based upon the processing of kinematic data given in real time during this match/training.

It should be also specified that this method can be used to obtain data and to evaluate players' performances in virtual sport simulations and/or events, such as for example matches performed through videogames or professional simulators for athletes.

Therefore, in view of the above description it is clear that by applying the method according to the present invention to a given player 21 based upon kinematic data collected during at least one match, but preferably a significant plurality of matches and/or training, it is possible to obtain a quantitative reliable description of the real technical, tactical and psychological skills of this given player. More in particular, by systematically applying this method to each player of a given team, it will be possible to obtain a quantitative description of the skills of the single players as well as of the entire team.

In view of the above description, the quantitative parameters calculated according to this method also allow to identify automatically the team player more suitable to play a given role in a formation and, consequently, it is possible to state that the application of this method allows to define through a quantitative effective process the best formation, i.e. the formation that, based upon the available players 21, presents the highest possibility of success on the field. In other words, application of this method presents the following advantages:

it supports trainers and managers in understanding the players' characteristics and therefore in optimising training procedures and identifying the ideal role for each player;

it supports trainers in selecting players' roles and defining the best team formation;

it supports trainers in identifying the best play model for his/her team;

it allows to minimise injuries resulting from an excessive work load exceeding the players' physical and/or technical characteristics;

it allows managers to have available quantitative evidences to verify performance of their trainers and team.

In the final analysis, the present method allows to implement a real virtual trainer, able to identify automatically the most effective formation and play module for a given team. This virtual trainer can be implemented through an electronic device designed to acquire input kinematic and/or personal data of the players 21, actuate the phases of the method according to the present invention through at least one respective computer, and, lastly, output the best formation and module for the players 21 available at that moment.

1. A method for obtaining data relating to the performance of at least one given participant in a sport event occurring on a given play surface and requiring the use of a given body suitable, in use, to be movable within said play surface, said method comprising:
a phase of acquiring kinematic data relating to at least one said given participant through tracking means for tracking the position of said participants during said sport event, followed by a phase of processing said kinematic data through programmable computing means;
said phase of processing said kinematic data comprises a phase of calculating the value of at least one given parameter (P, M, T) quantitatively describing said performance of at least one said given participant during said sport event;
wherein said phase of calculating the value of at least one given parameter (P, M, T) is preceded by a phase of identifying, based upon said kinematic data, a given portion of said play surface associated with a respective said given participant; and
wherein said given portion consisting of the set of all the points of the play surface where the respective said given participant can arrive before any other participant in a given time interval (ΔT).

2. A method according to claim 1, wherein:
said phase of calculating the value of at least one given parameter (P, M, T) is preceded by a phase of identifying for each said participant in the sport event a respective said portion of the play surface; and
each said portion being defined based upon said kinematic data and consisting of the set of all the points of the play surface where the respective said participant can arrive before any other said participant in a given time interval (ΔT).

3. A method according to claim 2, wherein said phase of calculating the value of at least one given parameter (P, M, T) is preceded by a phase of subdividing said play surface into a plurality of said portions whose overall number is equal to the number of the participants in said sport event.

4. A method according to claim 1, wherein said kinematic data relating to at least one said given participant comprise, alternatively or in combination, the trend over time of the position, of the speed and/or of the acceleration of said given participant during said sport event.

5. A method according to claim 1, wherein:
said phase of calculating the value of at least one given parameter (P, M, T) is preceded by a phase of acquiring personal data relating at least to said given participant; and
said personal data comprising, alternatively or in combination, data associated with a respective participant and relating to the respective athletic characteristics, to the respective current athletic condition and/or to the respective ability to face successfully a given type of sport events.

6. A method according to claim 5, wherein said phase of identifying a given portion associated with a said participant comprises a phase of numerically defining said given portion according to said given time interval (ΔT) and to at least one of said data relating to the athletic characteristics and/or to the current athletic condition of said participant.

7. A method according to claim 1, wherein:
said phase of calculating the value of at least one given parameter (P, M, T) comprises the phase of calculating the value of a first parameter (P, P′) suitable to quantify the performance of a said given participant during the execution of a given pass of said body to a further participant of the same team; and
this phase of calculating the value of the first value (P, P′) relating to a given pass of said body comprising the phase of calculating a difficulty coefficient (Cₙ) associated with said given pass.

8. A method according to claim 7, wherein:
said phase of calculating a difficulty coefficient (Cₙ) associated with said given pass comprises a phase of calculating the value of a function of at least one variable among the surface area (Aₙ) of the given portion associated with the participant receiving said given pass;
the flight time (Tₙ^{volo}) of the body during said pass;
the distance between the start position and the final position of the body during said given pass (Dₙ^{Pass});
the distance between the trajectory followed by said body during said given pass and at least one said given portion associated with an opponent of said team;
the distance between the trajectory followed by said body during said given pass and at least one said given portion associated with a participant member of said team different than the participant receiving said body following said given pass; and
the angle (ASₙ) that, in the initial moment of said given pass, presents the respective vertex in the position occupied by said body and the respective sides tangent to the two said given portions that are associated with the two opponents of said team who are nearest to the trajectory of said given pass.

9. A method according to claim 7, wherein:
said phase of calculating the value of a said first parameter (P, P′) comprises a phase of identifying the pass that, based upon said kinematic data, would have been the best one during said given pass;
said phase of identifying the pass the would have been the best pass comprising a phase of numerically maximising the value of a function calculated in the initial moment of said given pass and having at least one variable among the identity of said participant of said team to whom said body has been passed;
the surface area (Aₙ) of the given portion associated with said participant to whom said body has been passed;
the distance (Dₙ) between the given portion associated with said participant to whom said body has been passed and the centre of an area of the play surface associated with the goal area; and
said difficulty coefficient (Cₙ) associated with said given pass; at least one given success coefficient (Sₙ^{E}) quantifying the possibility of success of said participant to whom said body has been passed in a given event immediately after said given pass.

10. A method according to claim 9, said phase of calculating the value of a said first parameter (P, P′) comprises a phase of quantifying the ratio between said given pass really performed by said given participant and the pass that would have been the best pass for said given pass.

11. A method according to claim 1, wherein:
said phase of calculating the value of at least one given parameter (P, M, T) comprises the phase of calculating the value of a second parameter (T, T′) suitable to quantify the performance of a said given participant during the execution of a given shot of said body toward a given goal area; and
this phase of calculating the value of a second parameter (T, T′) relating to a given shot of said body comprising the phase of calculating a difficulty coefficient (Cₙ) associated with said given shot.

12. A method according to claim 11, wherein:
said phase of calculating a difficulty coefficient (Cₙ) associated with said given shot comprises a phase of calculating the value of a function of at least one variable among the surface area of said goal area, the surface area of a projection of said goal area relative to the position occupied by said given participant in the initial moment of said given shot;
the flight time of said body during said given shot;
the distance between the inside of said goal area and the position of said body in the initial moment of said given start shot;
the distance between the trajectory followed by said body during said given shot and at least one said given portion associated with an opponent of said team;
the distance between the trajectory followed by said body during said given shot and at least one said given portion associated with a participant member of said team different than the participant performing said given shot; and
the angle that, in the initial moment of said given shot, presents the respective vertex in the position occupied by said body and the respective sides tangent to the two said given portions that are associated with the two opponents of said team who are nearest to the trajectory of said given pass.

13. Method according to claim 11, wherein:
said phase of calculating the value of a said second parameter (T, T′) comprises a phase of identifying the shot of said body that, based upon said kinematic data, would have been the best shot for said given shot;
said phase of identifying the pass that would have been the best one comprising a phase of numerically maximising the value of a function calculated at the initial moment of said given pass and having at least one variable among the surface area of said goal area, the surface area of a projection of said goal area relative to the position occupied by said given participant in the initial moment of said given shot;
the distance between a said given portion associated with said given participant performing the given shot and the centre of said goal area; and
said difficulty coefficient (Cₙ) associated with said given shot.

14. A method according to claim 13, wherein said phase of calculating the value of a said second parameter (T, T′) comprises a phase of quantifying the ratio between said given pass really performed by said given participant and said shot that would have been the best shot on the occasion of said given shot.

15. A method according to claim 1, wherein:
said phase of calculating the value of at least one given parameter (P, M, T) comprises the phase of calculating the value of a third parameter (M) suitable to quantify the performance of a said given participant during the execution of a given displacement within said play surface;
this phase of calculating the value of a third parameter (M) relating to a given displacement of a said given participant comprising the phase of identifying the movement of said given participant that, on the base of said kinematic data, would have been the best displacement on occasion of said given displacement;
said phase of identifying the displacement that would have been the best displacement comprising a phase of numerically maximising the value of a function calculated with reference to the initial moment of said given displacement and having at least one variable among the area of the given portion associated with said given participant;
the difficulty coefficient (Cₙ) of a pass of said body directed toward said given participant or performed by said given participant; and
the surface area (Aₐᵥᵥ) of the given portion associated with an opponent opposing a pass or a shot of said body performed by said given participant.

16. A method according to claim 7, wherein said phase of identifying the displacement that would have been the best displacement comprising a said phase of calculating a said difficulty coefficient (Cₙ) associated with said pass of said body and/or a said phase of calculating a said difficulty coefficient (Cₙ) associated with said shot of said body.

17. A method as claimed in claim 15, wherein said phase of calculating the value of a said third parameter (M, M′) comprises a phase of quantifying the ratio between said given displacement really performed by said given participant and said displacement that would have been the best displacement.

18. A method according to claim 1, wherein said sport event is a football match or training and in that said body comprises a football ball.
